(19) United States
(12) Patent Application Publication
(10) Pub. No.: US 2025/0031277 A1
(43) Pub. Date: Jan. 23, 2025

(54) SUPPORTING EMERGENCY PREPAREDNESS COMMUNICATIONS IN OPENROAMING ENVIRONMENTS

(71) Applicant: Cisco Technology, Inc., San Jose, CA (US)

(72) Inventors: Sri Gundavelli, San Jose, CA (US); Mark Grayson, Maidenhead (GB); Brian Donald Hart, Sunnyvale, CA (US); Matthew Stephen MacPherson, Cary, NC (US); Pradeep Kumar Kathail, Los Altos, CA (US)

(21) Appl. No.: 18/513,013

(22) Filed: Nov. 17, 2023

Related U.S. Application Data
(60) Provisional application No. 63/514,466, filed on Jul. 19, 2023.

(51) Int. Cl. H04W 76/50; H04W 72/50; H04W 72/563

(52) U.S. Cl. CPC H04W 76/50; H04W 72/535; H04W 72/563

(57) ABSTRACT

In one aspect, a method for enabling EPCS in a network includes receiving a request from a network device to establish a connection to the network, wherein the request indicates an emergency event and at least one user equipment associated with the emergency event; prioritizing, for the network device, access to the network based on the request in accordance with a resource allocation policy comprising a plurality of access levels associated with a plurality of EPCS groups; allocating network resources in accordance with the resource allocation policy to the network device, wherein the one or more network resources are configured to modify a set of attributes of the network device to grant the network device an increased priority related to the emergency event; and transmitting a message to the network device to indicate authorization for the network device to establish a connection with the network according to the increased priority.

### CROSS-REFERENCE TO RELATED APPLICATIONS

This application claims priority to U.S. provisional application No. 63/514,466, filed on Jul. 17, 2023, the entire content of which is incorporated by reference herein in its entirety.

### FIELD OF THE TECHNOLOGY

The present disclosure relates to wireless communication systems, and in particular to improving reliability of high security and emergency preparedness communications services (EPCS) in Wireless Access Networks such as WiFi networks.

### BACKGROUND

National Security and Emergency Preparedness (NS/EP) personnel play a critical role in safeguarding communities and ensuring that essential services continue to function during emergency events. These personnel are often first responders, healthcare providers, law enforcement, and other professionals who are vital to the immediate and coordinated response to crises such as natural disasters, public health emergencies, or security threats.

Oftentimes, during such emergency events, communication networks can become strained and congested due to the increased volume of users attempting to access them simultaneously. This congestion poses a significant challenge as it can impede the timely and efficient exchange of crucial information among NS/EP personnel. In recognition of this challenge and the need to maintain uninterrupted communication for NS/EP personnel, regulatory authorities have established stringent requirements for prioritized access to communication networks during emergencies.

To meet these regulatory requirements and ensure that NS/EP personnel can effectively carry out their duties even in adverse network conditions, wireless network architectures have introduced the concept of the Emergency Preparedness Communications Service (EPCS). The EPCS feature is specifically designed to provide priority access to communication resources for NS/EP personnel, thereby ensuring that their critical communications take precedence over other traffic on the network. In essence, the EPCS feature acts as a lifeline during emergencies, allowing NS/EP personnel to communicate reliably and without interruption, even when the network experiences congestion. This prioritized access not only enhances the efficiency of emergency response efforts but also contributes to the overall safety and well-being of communities by ensuring that essential services remain operational when they are needed most.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic diagram of an example of an environment including home and visited wireless communication networks according to some aspects of the present technology;

FIG. 2 illustrates an example of a high-level network architecture according to some aspects of the present technology;

FIG. 3 illustrates a network architecture 300 for enabling Emergency Preparedness Communications Service (EPCS) in a network device according to some aspects of the present technology;

FIG. 4 illustrates a process for enabling Emergency Preparedness Communications Service (EPCS) in a network device according to some aspects of the present technology;

FIG. 5 illustrates an example communication network including one or more autonomous systems (ASes) according to some aspects of the present technology; and

FIG. 6 illustrates an example of a computing system according to some aspects of the present technology.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an Internet of things (IoT) network.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Aspects of the present disclosure are directed to providing solutions that bring an authorization structure and controls for EPCS enablement within the access network (e.g., on the ANP to IDP interfaces). The proposed solution considers the implementation of emergency access support through the OpenRoaming framework and expands this framework to include EPCS support. Enabling EPCS requires a coordinated decision by both the Access Network Provider and responsible Identity Provider for the specific emergency realm based on various factors such as the user's emergency realm, the location of the access network, the current time, and the nature of the emergency occurring in that area. It also includes specific elements that allocate wireless resources for emergency services.

In one aspect, a method for enabling Emergency Preparedness Communications Service (EPCS) in a network includes receiving a request from a network device to establish a connection to the network, wherein the request indicates an occurrence of an emergency event and at least one user equipment associated with the emergency event; prioritizing, for the device, access to the network based on the request in accordance with a resource allocation policy comprising a plurality of access levels associated with a plurality of EPCS groups; allocating one or more network resources in accordance with the resource allocation policy to the network device, wherein the one or more network resources are configured to modify a set of attributes of the network device to grant the network device with an increased priority related to the emergency event; and transmitting a message to the network device to indicate authorization for the network device to establish a connection with the network according to the increased priority.

In another aspect, the resource allocation policy further comprises defining access levels, each access level being based on at least a type of emergency event and a location of the emergency event.

In another aspect, the resource allocation policy further comprises defining access levels based on one or more priority levels for a number of user equipment associated with the emergency event, and a maximum medium time associated with each of the one or more priority levels.

In another aspect, allocating the one or more network resources includes monitoring utilization of the allocated network resources by the network device to identify compliance of the network device with the resource allocation policy; identifying an increase in a priority related to the emergency event; and in response to the identifying, updating the resource allocation policy to include access to the EPCS in the network for the at least one user equipment.

In another aspect, the message transmitted to the network device includes instructions for establishing a secure and prioritized connection to the network in accordance with the resource allocation policy and the increased priority related to the emergency event.

In another aspect, the method further includes receiving configuration information from an access network, wherein the configuration information specifies a limitation of emergency service to at least one EPCS group of the plurality of EPCS groups; configuring the allocation of network resources to the network device based on the received configuration information in accordance with the resource allocation policy; and wherein the limitation is specified via one or more bits in a Roaming Consortium Organization Identifier (RCOI).

In another aspect, the method further includes receiving a traffic specification indicator from the network device indicating one or more Quality of Service (QoS) requirements for an application flow related to the emergency event; analyzing the traffic specification indicator to identify a request to indicate priority for the application flow; and processing the request at the network based on the authorization in accordance with the resource allocation policy, wherein the network accepts or rejects the request based on a priority level of the emergency event and availability of the one or more network resources at the network.

In one aspect, a network controller is configured to enable Emergency Preparedness Communications Service (EPCS) in a network. The network controller includes one or more memories having computer-readable instructions stored therein and one or more processors. The one or more processors are configured to execute the computer-readable instructions to receive a request from a network device to establish a connection to the network, wherein the request indicates an occurrence of an emergency event and at least one user equipment associated with the emergency event; prioritize, for the device, access to the network based on the request in accordance with a resource allocation policy comprising a plurality of access levels associated with a plurality of EPCS groups; allocate one or more network resources in accordance with the resource allocation policy to the network device, wherein the one or more network resources are configured to modify a set of attributes of the network device to grant the network device with an increased priority related to the emergency event; and transmit a message to the network device to indicate authorization for the network device to establish a connection with the network according to the increased priority.

In one aspect, one or more non-transitory computer-readable media include computer-readable instructions, which when executed by one or more processors of a network controller, cause the network controller to receive a request from a network device to establish a connection to the network, wherein the request indicates an occurrence of an emergency event and at least one user equipment associated with the emergency event; prioritize, for the device, access to the network based on the request in accordance with a resource allocation policy comprising a plurality of access levels associated with a plurality of EPCS groups; allocate one or more network resources in accordance with the resource allocation policy to the network device, wherein the one or more network resources are configured to modify a set of attributes of the network device to grant the network device with an increased priority related to the emergency event; and transmit a message to the network device to indicate authorization for the network device to establish a connection with the network according to the increased priority.

### EXAMPLE EMBODIMENTS

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

During emergency situations, it is essential to provide priority communication access to National Security and Emergency Preparedness (NS/EP) personnel. These dedicated professionals, including first responders, healthcare providers, and law enforcement, are the backbone of emergency response efforts with regard to natural disasters and other emergency recovery efforts when requested. Their ability to communicate swiftly and effectively can make the crucial difference between life and death for those affected by the emergency. Prioritized communication channels are not merely a convenience, they are a lifeline that enables critical information to flow seamlessly, facilitating timely rescue and assistance. Furthermore, this priority access allows for coordinated responses among multiple agencies, efficient resource allocation, and the dissemination of vital information to the public, minimizing panic and ensuring the safety and well-being of our communities. Compliance with regulatory mandates governing NS/EP communication access is both a legal obligation and a moral duty to protect and support those who safeguard our lives and security during times of crisis.

During crises, emergency personnel's ability to communicate swiftly and effectively is paramount, often making the difference between life and death for those in need. EPCS provides the critical priority access required to ensure that NS/EP communication remains uninterrupted, allowing these dedicated professionals to coordinate responses, allocate resources efficiently, and disseminate vital information to the public. EPCS provides the ability to prioritize NS/EP communication traffic, granting it precedence over non-emergency messages. In the chaos of emergencies, the reliability of wireless networks is put to the test. EPCS steps in to enhance this reliability by reserving essential bandwidth and network resources for NS/EP use. This proactive approach mitigates the risk of network congestion, safeguarding the continuity of communication when it matters most.

Furthermore, EPCS fosters seamless coordination among various NS/EP entities, local authorities, and other stakeholders involved in emergency response efforts. This coordination is the linchpin of efficient and effective crisis management, enabling resources to be deployed precisely where needed and facilitating informed decision-making. Thus, EPCS is able to provide situation awareness to real-time emergency events to provide NS/EP personnel with access to real-time information during emergencies to make informed decisions, adapt response strategies, and ensure the safety of responders and the public. Thus, EPCS ensures this vital flow of information, empowering those on the front lines with the knowledge they need to act decisively without interruption, latency issues, or downtime within a wireless network.

To meet this requirement, the Emergency Preparedness Communications Service (EPCS) feature has been established in wireless architectures. One of these mechanisms is the deployment of Wireless Priority Service (WPS) in public networks, as described in TS 22.153. This system allows national regulators to activate the service on each cellular network as needed.

In addition, Wi-Fi access in 802.11 also supports EPCS. To give priority treatment to NS/EP signaling and user traffic, Enhanced Distributed Channel Access (EDCA) parameters are used. The Wi-Fi Access Point usually provides EDCA parameters to the connected devices, which controls their contention behavior for the wireless medium. By adjusting the device behavior during access attempts, EDCA parameters improve the performance of specific types of traffic. When EPCS is turned on an Access Point (AP), non-EPCS devices are given degraded EDCA parameters, including longer contention window limits and arbitration inter-frame spacing. This prioritizes EPCS-enabled devices, ensuring their critical communications are given priority over others.

Currently, there are challenges to the widespread adoption and certification of EPCS capability. It can be difficult to identify which traffic types require prioritization at the access network and determine the need for priority access. It's crucial to distinguish between scenarios, such as a fire crew's routine coffee break versus their presence at the coffee shop to respond to an emergency, for effective implementation of EPCS.

As noted above, the proposed technology involves implementing an authorization structure and controls for EPCS enablement (e.g., on the ANP to IDP interfaces). As will be described, doing so can include extending the OpenRoaming framework to support emergency access and EPCS. To enable EPCS, both the Access Network Provider and responsible Identity Provider of the specific emergency realm work together to make a coordinated decision based on factors such as the user's emergency realm, location of the access network, current time, and the nature of the emergency in that area. Furthermore, this solution includes specific elements that allocate wireless resources for emergency services.

Enabling EPCS involves a joint decision made by an Access Network Provider (ANP) and a responsible Identity Provider (IDP), specifically for the emergency realm in question. Several factors, such as the user's emergency realm, the location of the access network, the current time, and the type of emergency taking place in the area, determine this decision. Moreover, it includes details on how wireless resources designated for emergency services are allocated.

Implementing Emergency Preparedness Communications Service (EPCS) demands meticulous consideration of key factors to ensure its efficiency and responsible usage. First and foremost, the enablement of EPCS should be context-specific, contingent on the emergency's nature, individual identity verification, and location. Adopting a blanket approach, akin to 3GPP's NS/EP, granting access to all emergency personnel irrespective of circumstances, is not a pragmatic approach. Access should be based on specific identity groups or authorized realms, such as .gov or gov.uk, associated with the emergency's operational scope.

Secondly, establishing a hierarchical access priority system can assist with aligning users' roles and classifications within the emergency management framework. The IDP should possess the discretion to grant EPCS access to specific groups based on various factors, including user realm, geographical location, situation, and timing.

Furthermore, safeguards may be put in place to protect the access rights of non-EPCS users. Access networks should allocate a defined portion of their resources to prioritize EPCS traffic, all the while ensuring that non-EPCS users continue to receive an adequate quality of service.

Lastly, robust accountability mechanisms are paramount for the provision of EPCS services. Access network providers may possess the capability to monitor and account for the resources allocated to EPCS, including their impact on non-EPCS users. This accountability extends to the ability to invoice regulatory entities for priority access provision, ensuring sustainable support for EPCS.

The proposed technology allows for OpenRoaming to be used in systems that have multiple Roaming Consortium Organization Identifiers (RCOIs). This helps to ensure that policies are followed consistently across the federation. The RCOIs can be either OpenRoaming-Settled or OpenRoaming-Settlement-Free, and it's also possible to create a new RCOI specifically for Emergency Services. Devices that have a Passpoint profile matching any of these RCOIs will be authorized for EPCS enablement.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an Internet of things (IoT) network.

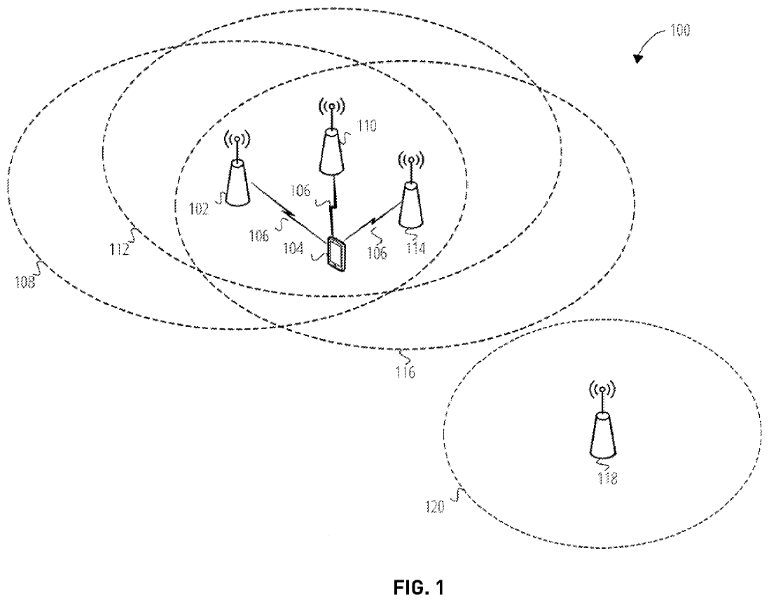

FIG. 1 shows a block diagram of an example a roaming scenario according to some aspects of the present disclosure. The roaming scenario 100 can include a radio access network (RAN) 118 for a home public land mobile network (HPLMN) and RANs for several visited public land mobile network (VPLMN), which are illustrated by RAN 102 for a VLPMN-A, RAN 110 for VLPMN-B, and RAN 114 for VLPMN-C. In FIG. 1, the user equipment (UE) 104 is out of the coverage area 120 of RAN 102 and the HPLMN, but the UE 104 is within the coverage area 108 of the VPLMN-A. Additionally, the UE 104 is within the coverage area 108 of the VPLMN-B, and the UE 104 is within the coverage area 116 of the VPLMN-C. Respective communication links 106 can connect the UE 104 to each of the RANs 102, 110, and 114.

In the roaming scenario 100, the UE 104 is a subscriber to the HPLMN, and, when the UE 104 leaves the coverage area 120 of the HPLMN, roaming allows the UE 104 to continue to send and receive messages with by using one of the VPLMNs. The UE 104

In wireless telecommunications, the term “roaming” can refer to a situation in which mobile devices (e.g., UE 104) are being used outside the range of its native network by connecting to another available cell network. Further, roaming can refer to a functionality in which a cellular customer uses a visited network to automatically make and receive voice calls, send and receive data, or access other services, including home data services, when travelling outside the geographical coverage area of the home network. For example, should a subscriber travel beyond their cell phone company's transmitter range, their cell phone would automatically hop onto another phone company's service, if available. The term “home network” refers to the network the subscriber is registered with, and “visited network” refers to the network a subscriber roams temporarily and is outside the bounds of the home network. The legal roaming business aspects negotiated between the roaming partners for billing of the services obtained are usually stipulated in roaming agreements

3GPP supports steering of roaming (SoR) in which a Home PLMNs uses a roaming partners list (RPL) to steer their roaming subscribers to preferred partner networks by means of updating the Operator Controlled PLMN Selector list via signaling. Using the RPL, an operator can direct a UE 104 to latch on to preferred roaming partner via SoR based on roaming agreement/costs.

In FIG. 1, the UE 104 can latch onto one of the roaming partners VPLMN-A, VPLMN-B, and VPLMN-C. The RPL can be used to ensure that the UE 104 latches onto the visited network with the most favorable roaming agreement/costs. But sometimes the UE 104 can require services/features that are only available from some of the visited networks. The systems and methods described herein overcome this limitation by augmenting the roaming steering process to provide network capability awareness.

Consider an example in which, the UE 104 enables an Access Traffic Steering, Switching and Splitting (ATSSS) feature while roaming, The ATSSS feature allows the diversion of some traffic over Non-3GPP access. Not all visited networks will support ATSSS. Thus, to ensure that the UE 104 latches on to a visited network that supports the desired network capability (i.e., ATSSS in this case), the UE 104 would need to be aware of which visited networks support the desired network capability. For example, it is possible that a given visited network supports both 3GPP/Non-3GPP access but does not support ATSSS, which depends on several enhancements in the core network (e.g., ATSSS-LL, MPTCP, MPTCP Proxy, etc.).

Currently, 3GPP lacks such information as part of RPL in the SoR and there is no way for UE 104 to selectively latch on the visited network where certain specific network capabilities are supported. Although access technology and slice is part of the SoR information which can be used by UE 104 to select a particular visited network based on the supported slice, in the RPL generated by SoR that is provided in 3GPP, the capabilities provided by the visited network are not accounted for, such that a UE 104. If, however, the capabilities provided by the visited network were accounted for (as is the case for certain systems and methods disclosed herein), then the RPL generated by SoR would enable the UE 104 to latch on to the preferred visited network that has the desired network capabilities. The above example in which the desired network capability is ATSSS is non-limiting, and the desired network capability can be any existing network capability or any network capability that is developed in the future. For example, there are many such capabilities supported by 5GC (ATSSS, non-regulatory Location services or TSN) which may/may not be supported by a visited network. Therefore, bringing network capabilities level cognizance in the RPL is beneficial to enable UEs to select the most appropriate visited network that serves the UEs needs.

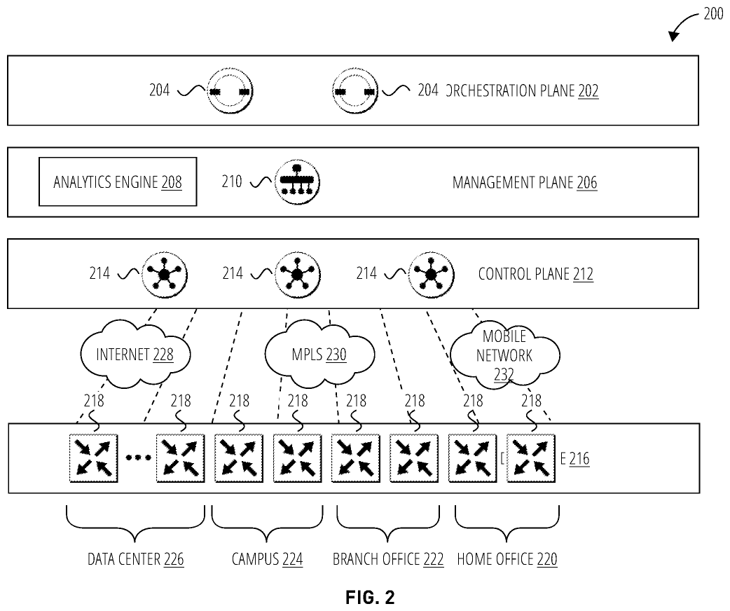

FIG. 2 illustrates an example of a network architecture 200 for implementing aspects of the present technology. An example of an implementation of the network architecture 200 is the Cisco® SD-WAN architecture. However, one of ordinary skill in the art will understand that, for the network architecture 200 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 200 can comprise an orchestration plane 202, a management plane 206, a control plane 212, and a data plane 216. The orchestration plane 202 can assist in the automatic on-boarding of edge network devices 218 (e.g., switches, routers, etc.) in an overlay network. The orchestration plane 202 can include one or more physical or virtual network orchestrator appliances 204. The network orchestrator appliances 204 can perform the initial authentication of the edge network devices 218 and orchestrate connectivity between devices of the control plane 212 and the data plane 216. In some embodiments, the network orchestrator appliances 204 can also enable communication of devices located behind Network Address Translation (NAT). In some embodiments, physical or virtual Cisco® SD-WAN vBond appliances can operate as the network orchestrator appliances 204.

The management plane 206 can be responsible for central configuration and monitoring of a network. The management plane 206 can include analytics engine 208 and one or more physical or virtual network management appliances 210. In some embodiments, the network management appliances 210 can provide centralized management of the network using output and data provided by analytics engine 208, and via a graphical user interface to enable a user to monitor, configure, and maintain the edge network devices 218 and links (e.g., Internet transport network 228, MPLS network 230, 4G/mobile network 232) in an underlay and overlay network. The network management appliances 210 can support multi-tenancy and enable centralized management of logically isolated networks associated with different entities (e.g., enterprises, divisions within enterprises, groups within divisions, etc.). Alternatively, or in addition, the network management appliances 210 can be a dedicated network management system for a single entity. In some embodiments, physical or virtual Cisco® SD-WAN vManage appliances can operate as the network management appliances 210.

The control plane 212 can build and maintain a network topology and make decisions on where traffic flows. The control plane 212 can include one or more physical or virtual network control appliances 214. The network control appliances 214 can establish secure connections to each edge network device 218 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 214 can operate as route reflectors. The network control appliances 214 can also orchestrate secure connectivity in the data plane 216 between and among the edge network devices 218. For example, in some embodiments, the network control appliances 214 can distribute crypto key information among the edge network devices 218. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 214.

The data plane 216 can be responsible for forwarding packets based on decisions from the control plane 212. The data plane 216 can include the edge network devices 218, which can be physical or virtual edge network devices. The edge network devices 218 can operate at the edges various network environments of an organization, such as in one or more data centers 226, campus networks 224, branch office networks 222, home office networks 220, and so forth, or in the cloud (e.g., Infrastructure as a Service (IaaS), Platform as a Service (PaaS), SaaS, and other cloud service provider networks). The edge network devices 218 can provide secure data plane connectivity among sites over one or more WAN transports, such as via one or more Internet transport networks 228 (e.g., Digital Subscriber Line (DSL), cable, etc.), MPLS networks 230 (or other private packet-switched network (e.g., Metro Ethernet, Frame Relay, Asynchronous Transfer Mode (ATM), etc.), mobile networks 232 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 218 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as the edge network devices 218.

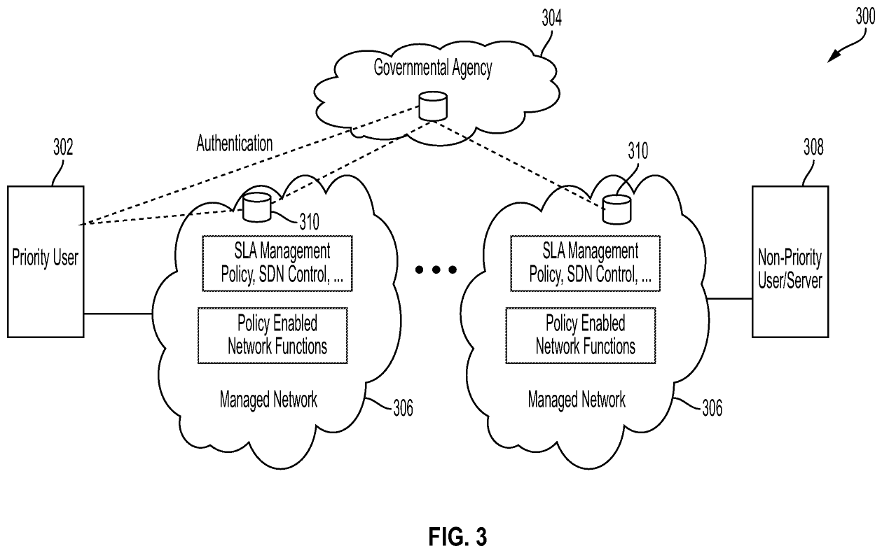

FIG. 3 illustrates a network architecture 300 for enabling Emergency Preparedness Communications Service (EPCS) in a network device according to some aspects of the present technology. The proposed technology, as depicted by FIG. 3, allows for OpenRoaming to be used in systems that have multiple Roaming Consortium Organization Identifiers (RCOIs). This helps to ensure that policies are followed consistently across the federation.

The integration of Emergency Preparedness Communications Service (EPCS) with OpenRoaming can yield significant benefits in emergency scenarios. OpenRoaming's seamless and secure connectivity capabilities can ensure that NS/EP personnel maintain uninterrupted communication access across various wireless networks. This interoperability enhances the reliability of EPCS by expanding its coverage and reducing the risk of network congestion during emergencies. With this expanding coverage, and reduction of interference NS/EP personnel can seamlessly roam between different networks while maintaining their prioritized access, ensuring that crucial communications are never compromised. Moreover, OpenRoaming's can provide for increased security that can bolster the confidentiality and integrity of EPCS communications, safeguarding sensitive information and enabling secure coordination during critical situations.

The network architecture 300 includes a priority user network device 302 that can include network devices belonging to NS/EP personnel. NS/EP personnel via the priority user network device 302 can submit a request to access a managed network 306 that is also accessible by non-priority user network devices 308, belonging to non-NS/EP personnel or communications from devices that do not include NS/EP communications.

National Security and Emergency Preparedness (NS/EP) network devices including the priority user network device 302, depicted in FIG. 3, can initiate the process of requesting access to a managed network 306 by sending a request to the Access Network Provider (ANP) 310 responsible for the managed network 306. This request can be triggered when an emergency event occurs or when an NS/EP user of the priority user network device 302 requires prioritized communication access. The request can include request data including information related to the nature of the emergency, the identity of the user, and the group or realm associated with the user's emergency access.

Upon receiving the access request, the ANP 310 facilitates access for the priority user network device 302. The ANP 310 is responsible for validating the user's credentials, assessing the nature of the emergency, and ensuring that the user is authorized for Emergency Preparedness Communications Service (EPCS). The ANP 310 may use various mechanisms, including identity verification and realm-based authorization, to determine the user's eligibility for EPCS access.

In some example, the ANP 310 can assess whether the priority user network device 302 belongs to at least one emergency access group that is associated with a common or dedicated realm (domain). For example, the ANP 310 can determine that the identity of the priority user network device 302 is associated with emergency access group realms (non-limiting examples of realms/domains include @sos.firefighters.org, @sos.emergencymedicalservices.org, @sos.emergencydispatcher.org, @sos.hazardousmaterials.org, @sos.emergencycommunications.org, @sos.publicworks.org, @sos.disasterresponseteams.org,” etc.).

Once the ANP 310 has assessed the access request and confirmed the user's eligibility and association with an emergency-related realm, the ANP 310 can transmit the request to an Identity Provider (IDP) 304 responsible for making the final determination. The IDP 304 can evaluate the request based on predefined criteria, which may include the user's realm, location, specific emergency group, and the nature of the emergency event. The IDP can further validate the request, ensure it aligns with regulatory requirements, and grant or deny access accordingly. In some examples, the IDP 304 can be associated with a government or federal entity that is empowered with assessing emergency and natural disaster responses and prioritizing the responses to ensure that proper communication access is provided to essential priority user network devices 302.

The IDP 304 can perform an authentication process. This process can include identifying the priority user network devices 302 realm, which represents a specific domain or organization associated with emergency services, and verifying the user's legitimacy and affiliation with authorized groups eligible for EPCS access. The IDP 304 can further evaluate the geographic context of the request, recognizing that access priority may fluctuate based on specific emergency events in different coverage regions of the managed network 306.

Additionally, time-based considerations form another aspect of the authentication and authorization process. The current time of emergency events can be factored in to assess whether the access request aligns with the specified timeframes for priority access. Different emergency scenarios might necessitate elevated access privileges only during particular hours or specific time periods.

Furthermore, the nature of the emergency occurring in the area can be another factor to be taken into consideration. The IDP 304 thoroughly evaluates the type and severity of the emergency, recognizing that not all emergencies are equal in terms of their impact on communication networks. Depending on the specific circumstances, the IDP 304 may adjust access priorities accordingly to address the unique demands of the situation.

When deciding which priority user network devices 302 should be granted access to the managed network 306, the IDP 304 takes various factors into account. To do this, the IDP 304 may create an EPCS resource allocation policy that contains predetermined rules (rules can be configurable and determined based on experiments and/or empirical studies). These rules can assign higher priority access to specific areas and emergency access groups during designated emergency situations. The EPCS resource allocation policy can include a plurality of policy attributes for establishing one or more levels of prioritization for EPCS communications from priority user network devices 302, while also ensuring resource protection for non-EPCS communications associated with non-priority user network device 308.

In some examples, the EPCS resource allocation policy can include rules to establish a robust resource allocation policy for EPCS. One rule within the resource allocation policy can pertain to the allocation limit for EPCS traffic. For instance, to maintain network efficiency, no more than a specified percentage of the available medium time may be allocated for prioritized e911 EPCS traffic. This percentage can be a configurable parameter and determined based on experiments and/or empirical studies. For example, 15% of available medium time as an illustrative example, can ensure that EPCS traffic receives a substantial share of network resources without overwhelming the network. Similarly, the policy can extend to encompass the allocation limit for general EPCS traffic, ensuring that no more than a defined percentage of the medium time is dedicated to prioritized EPCS traffic. This allocation prevents any single category of traffic from monopolizing network resources, maintaining fairness in resource distribution. Furthermore, a facet of the policy involves a combined allocation for both EPCS and e911 Users. This approach aims to strike a balance between different types of priority traffic, with the policy articulating that no more than 20% of the medium time should be allotted for both e911 Users and EPCS traffic. This equilibrium ensures that both emergency communication and general EPCS traffic receive the bandwidth the need.

In some examples, to effectively identify and prioritize EPCS traffic, the policy can underscore the use of Advanced Video Coding (AVC) rules. Thus, these rules can prove to be instrumental in distinguishing EPCS traffic from other data streams, facilitating precise prioritization and resource allocation.

In another example, the introduction of an EPCS-Policy tag can offer a streamlined approach to establishing the EPCS resource allocation policy. The EPCS-Policy tag can function as a distinctive marker enabling the access network to effortlessly recognize and apply a predefined policy template specific to EPCS traffic. This mechanism can simplify the implementation of EPCS resource allocation policies, ensuring they align seamlessly with the prioritization requirements for emergency communication.

Upon evaluating these multifaceted factors and the policy EPCS resource allocation policy, the IDP 304 can provide a well-informed determination regarding the access request. If the request aligns with the established parameters of the EPCS resource allocation policy, the IDP 304 can include an EPCS-Grant attribute in a response to the request, providing explicit authorization for the user's network device to establish a connection with the EPCS.

The EPCS resource allocation policy can further be transmitted to the ANP 310. The ANP 310 can use the EPCS-Grant to confirm that the priority user network device 302 has access to the managed network 306, and subsequently authorizes and enables access for the priority user network device 302. The ANP 310 may restrict emergency service support to certain EPCS service groups based on the EPCS resource allocation policy or saved configurations at the ANP. The ANP can also indicate which specific emergency groups are supported by setting the one or more RCOI bits (e.g., can be any one or more bits such as first bit, first two bits, last bit, last two bits, etc.).

In some examples, upon the priority user network device 302 being provided authorization to access the managed network 306, the priority user network device 302 can signal a traffic specification (TSPEC) to the access point for signaling its quality of service (QoS) requirements for communications (traffic flow) to and from the priority user network device 302. The TSPEC includes a set of parameters, characteristics, and Quality of Service expectations of communications from the priority user network device 302 to and from the managed network 306. The TSPEC element can be utilized in a basic Add Traffic Stream (ADDTS) frame to request bandwidth, and indicate priority of the priority user network device 302 using Expedited Bandwidth Request (EBR). The ANP 310 can accept/reject the TSPEC request based on the authorization from the IDP and in consideration for the allocation of EPCS resources. Alternatively, or additionally priority user network device 302 can send a QoS characteristics element in a subcarrier spacing (SCS) request frame as part of establishing an SCS agreement with an access point of the managed network 306.

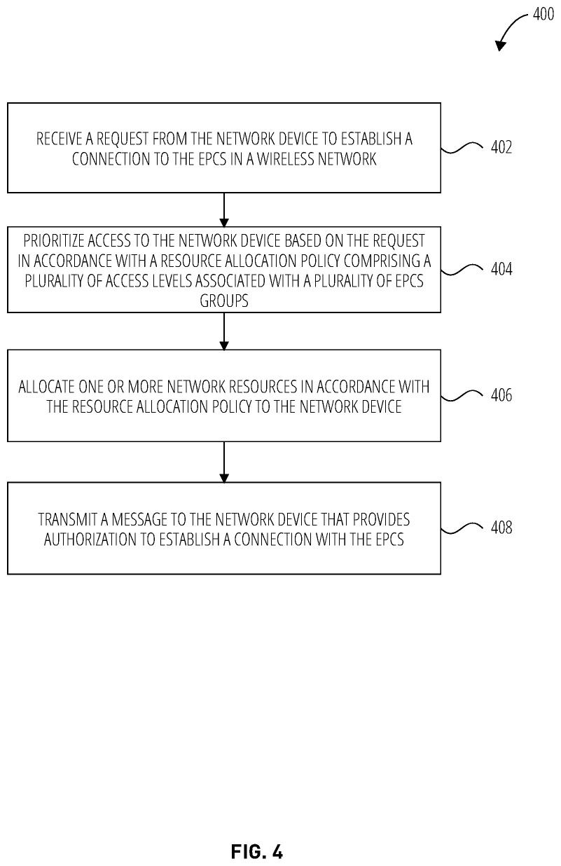

FIG. 4 illustrates a process for enabling Emergency Preparedness Communications Service (EPCS) in a network device according to some aspects of the present technology. Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence. For sake of describing non-limiting examples of the present disclosure, steps of FIG. 4 will be described from the perspective of a network controller (e.g., a network controller of a wireless network providing EPCS such as a controller of the managed network 306).

At block 402, a request from the network device can be received at the network controller to establish a connection to the EPCS in a wireless network. In some examples, the ANP 310 illustrated in FIG. 3 may receive a request from the priority user network device 302 to establish a connection to the EPCS in the managed network 306. In some examples, the request indicates an occurrence of an emergency event and at least one user equipment associated with the emergency event.

In some examples, a traffic specification indicator can be received from the network device indicating one or more Quality of Service (QoS) requirements for an application flow related to the emergency event. For example, the ANP 310 illustrated in FIG. 3 may receive a traffic specification indicator from the network device indicating one or more Quality of Service (QoS) requirements for an application flow related to the emergency event.

In some examples, the traffic specification indicator can be analyzed to identify a request to indicate priority for the application flow. For example, the ANP 310 illustrated in FIG. 3 may analyze the traffic specification indicator received from the priority user network device 302 to identify a request to indicate priority for the application flow.

In some examples, the request can be processed at the managed network based on the authorization received by the network device in accordance with the resource allocation policy. For example, the ANP 310 illustrated in FIG. 3 may process the request at the priority user network device 302 based on the authorization received from the IDP 304 by the network device and the ANP 310 in accordance with the resource allocation policy. The ANP 310 can accept or reject the request based on a priority level and availability of one or more network resources for the EPCS.

At block 404, the network controller can prioritize access for the network device based on the request in accordance with a resource allocation policy comprising a plurality of access levels associated with a plurality of EPCS groups. For example, the ANP 310 at the managed network 306, illustrated in FIG. 3 may prioritize access to the priority user network device 302 based on the request in accordance with a resource allocation policy received from the IDP 304 comprising a plurality of access levels associated with a plurality of EPCS groups. In some examples, the resource allocation policy can further comprise defining access levels based on a type of emergency event and the location of the emergency event.

At block 406, the network controller can allocate one or more resources to the network device in accordance with the resource allocation policy. For example, the ANP 310 illustrated in FIG. 3 may allocate one or more network resources in accordance with the resource allocation policy to the network device. In some examples, the one or more network resources are configured to modify a set of attributes of the priority user network device 302 to grant the priority user network device 302 an increased priority related to the emergency event. In some examples, the resource allocation policy further comprises defining access levels based on one or more priority levels for a number of priority user network devices 302 associated with the emergency event, and a predetermined maximum medium time associated with each priority level.

In some examples, utilization of the allocated network resources by the network devices can be monitored by the network to identify compliance of the network devices with the resource allocation policy. For example, the ANP 310 illustrated in FIG. 3 may monitor utilization of the allocated network resources used by the priority user network devices 302 to identify compliance of the network device with the resource allocation policy.

In some examples, the allocation of resources to the network device can be configured based on the received configuration information in accordance with the resource allocation policy. For example, the IDP 304 illustrated in FIG. 3 may configure the allocation of network resources to the network device based on the received configuration information in accordance with the resource allocation policy. The access network may set specific one or more bits in the RCOI to indicate support for the at least one EPCS groups.

In some examples, an increase in priority related to the emergency event can be identified. For example, the IDP 304 illustrated in FIG. 3 may identify an increase in priority related to the emergency event due to a change in location, or characteristics related to the emergency event.

In some examples, the resource allocation policy can be updated to include access to the EPCS for at least one user equipment depending on such change and hence the increase in priority. For example, the IDP 304 illustrated in FIG. 3 may update the resource allocation policy to include access to the EPCS for at least one user equipment.

At block 408, the network controller can transmit a message to the network device that provides authorization to establish a connection with the EPCS. For example, the ANP 310 illustrated in FIG. 3 may transmit a message to the priority user network device 302 that provides authorization to establish a connection with the EPCS. In some examples, the ANP 310 authorizes the at least one user equipment to access EPCS in accordance with the policy. In some examples, the message transmitted to the priority user network device 302 includes instructions for establishing a secure and prioritized connection to the Emergency Preparedness Communications Service (EPCS) in accordance with the resource allocation policy and the increased priority related to the emergency event.

In some examples, configuration information can be received from an access network. For example, the managed network 306 illustrated in FIG. 3 may receive configuration information from the IDP 304. The configuration information can specify a limitation of emergency service including support to all, none, or at least one EPCS group in the plurality of EPCS groups.

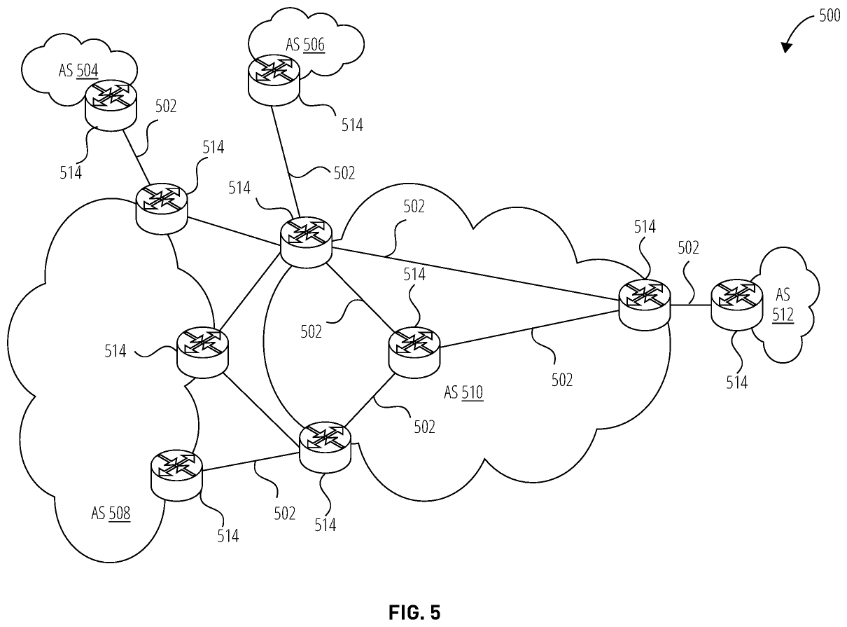

FIG. 5 illustrates an example communication network 500 including one or more autonomous systems (ASes) according to some aspects of the present technology. Example embodiments described above for providing priority communication access to certain type of communications (e.g., communications by and to National Security and Emergency Preparedness (NS/EP) personnel) may be implemented within an inter-connected network of ASes such as communication network 500.

A computer network 500 is a geographically distributed collection of nodes interconnected by communication links and segments for transporting data between end nodes, such as personal computers and workstations, or other network devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other.

Since management of interconnected computer networks 500 can prove burdensome, smaller groups of computer networks may be maintained as routing domains or autonomous systems. An Autonomous System (AS) is a network or group of networks under common administration and with common routing policies. A typical example of an AS is a network administered and maintained by an Internet Service Provider (ISP). Customer networks, such as universities or corporations, connect to the ISP, and the ISP routes the network traffic originating from the customer networks to network destinations that may be in the same ISP or may be reachable only through other ISPs.

To facilitate the routing of network traffic through one or more ASes, the network elements of the ASes need to exchange routing information to various network destinations. Border Gateway Protocol (BGP) is an Exterior Gateway Protocol (EGP) that is used to exchange routing information among network elements (e.g., routers) in the same or different ASes. A computer host that executes a BGP process is typically referred to as a BGP host or a BGP network device. To exchange BGP routing information, two BGP hosts, or peers, first establish a transport protocol connection with one another. Initially, the BGP peers exchange messages to open a BGP session, and, after the BGP session is open, the BGP peers exchange their entire routing information. Thereafter, only updates or changes to the routing information are exchanged, or advertised, between the BGP peers. The exchanged routing information is maintained by the BGP peers during the existence of the BGP session.

The networks within an AS are typically coupled together by conventional “intradomain” routers configured to execute intradomain routing protocols, and are generally subject to a common authority. To improve routing scalability, a service provider (e.g., an ISP) may divide an AS into multiple “areas” or “levels.” It may be desirable, however, to increase the number of nodes capable of exchanging data; in this case, interdomain routers executing interdomain routing protocols are used to interconnect nodes of the various ASes. Moreover, it may be desirable to interconnect various ASes that operate under different administrative domains. As used herein, an AS, area, or level is generally referred to as a “domain.”

FIG. 5 is a schematic block diagram of an example computer network 500 illustratively comprising network devices 514 interconnected by various methods of communication. For instance, the links 502 may be any suitable combination of wired links and shared media (e.g., wireless links, Internet Exchange Points, etc.) where certain network devices 514, such as, e.g., routers, computers, etc., may be in communication with other network devices 514, e.g., based on distance, signal strength, current operational status, location, etc. Those skilled in the art will understand that any number of network devices 514, links, etc. may be used in the computer network, and that the view shown herein is for simplicity.

Data packets (e.g., traffic and/or messages sent between the network devices 514) may be exchanged among the network devices 514 of the computer network 500 using predefined network communication protocols such as certain known wired protocols, as well as wireless protocols or other shared-media protocols where appropriate.

The computer network 500 includes a set of autonomous systems (AS) 504, 506, 508, 510 and 512. The computer network 500 may be positioned in any suitable network environment or communications architecture that operates to manage or otherwise direct information using any appropriate routing protocol or data management standard. For example, computer network 500 may be provided in conjunction with a border gateway protocol (BGP).

As noted above, an AS may be a collection of connected Internet Protocol (IP) routing network devices 514 under the control of one or more network operators that presents a common, clearly defined routing policy to a network (e.g., the Internet). Usually, an AS comprises network devices 214 that are established on the edge of the system, and that serve as the system's ingress and egress points for network traffic. Moreover, the network devices 514 may be considered edge network devices, border routers, or core network devices within the respective AS. These network devices typically, but not always, are routers or any other element of network infrastructure suitable for switching or forwarding data packets according to a routing protocol or switching protocol. For the purposes of the present disclosure, the network devices 514 located within an AS may alternatively be referred to as “forwarding network devices” or “intermediate network devices.” Moreover, for illustration purposes, the ASes 504, 506, 508, 510 and 512 are shown with a limited number of network devices 514. In an actual implementation, however, an AS normally comprises numerous routers, switches, and other elements.

Each AS 504, 506, 508, 510 and 512 may be associated with an Internet Service provider (ISP). Even though there may be multiple ASes supported by a single ISP, the Internet only sees the routing policy of the ISP. That ISP can have an officially registered Autonomous System Number (ASN). As such, a unique ASN is allocated to each AS for use in BGP routing. ASNs are important primarily because they uniquely identify each network on the Internet.

To facilitate the routing of network traffic through the ASes, or more specifically, the network devices 514 within the ASes, the network devices may exchange routing information to various network destinations. As described above, BGP is conventionally used to exchange routing and reachability information among network devices 514 within a single AS or between different ASes. One particular example of BGP is BGPv4, as defined in Request for Comments (RFC) 1771 of the Internet Engineering Task Force (IETF). Various embodiments may implement other versions of BGP, however, and the use of BGPv4 is not required. The BGP logic of a router is used by the data collectors to collect BGP AS path information, e.g., the “AS_PATH” attribute, as described further below, from BGP tables of border routers of an AS, to construct paths to prefixes.

To exchange BGP routing information, two BGP hosts (network devices 514), or peers, first establish a transport protocol connection with one another. Initially, the BGP peers exchange messages to open a BGP session, and, after the BGP session is open, the BGP peers exchange their entire routing information. Thereafter, in certain embodiments, only updates or changes to the routing information, e.g., the “BGP UPDATE” attribute, are exchanged, or advertised, between the BGP peers. The exchanged routing information is maintained by the BGP peers during the existence of the BGP session.

The BGP routing information may include the complete route to each network destination, e.g., “destination network device,” that is reachable from a BGP host. A route, or path, comprises an address destination, which is usually represented by an address prefix (also referred to as prefix), and information that describe the path to the address destination. The address prefix may be expressed as a combination of a network address and a mask that indicates how many bits of the address are used to identify the network portion of the address. In Internet Protocol version 4 (IPv4) addressing, for example, the address prefix can be expressed as “9.2.0.2/16”. The “/16” indicates that the first 16 bits are used to identify the unique network leaving the remaining bits in the address to identify the specific hosts within this network.

A path joining a plurality of ASes, e.g., links 502, may be referred to as an “AS_PATH.” The AS_PATH attribute indicates the list of ASes that is/are be traversed to reach the address destination. For example, as illustrated in FIG. 2, the AS 504 may store an AS_PATH attribute of “504, 506, 508, 510 and 512” where the address destination is the AS 504 (or a particular IP address within AS 512). Here, the AS_PATH attribute indicates that the path to the address destination AS 512 from AS 508 passes through ASes 504, 506 and 510, in that order.

Although it may be preferable that all network devices 514 in the respective ASes 504, 506, 508, 510 and 512 be configured according to BGP, in a real-world implementation, it may be unlikely that each network device communicates using BGP. Thus, the disclosed embodiments are applicable to scenarios where all network devices 514 in the computer network 200 are configured according to BGP, as well as scenarios where only a subset of the network devices 514 is configured as such. Moreover, between any of the ASes, there may be a single communication path 502, e.g., between AS 504 and AS 508, as shown in FIG. 2, or there may be multiple communication paths 502, e.g., between AS 508 and AS 510. Thus, the disclosed embodiments are applicable to either case, as described in further detail below.

Moreover, a security extension to the BGP has been developed, referred to as BGPSEC, which provides improved security for BGP routing. BGP does not include mechanisms that allow an AS to verify the legitimacy and authenticity of BGP route advertisements. The Resource Public Key Infrastructure (RPKI) provides a first step towards addressing the validation of BGP routing data. BGPSEC extends the RPKI by adding an additional type of certificate, referred to as a BGPSEC router certificate, that binds an AS number to a public signature verification key, the corresponding private key of which is held by one or more BGP speakers within this AS. Private keys corresponding to public keys in such certificates can then be used within BGPSEC to enable BGP speakers to sign on behalf of their AS. The certificates thus allow a relying party to verify that a BGPSEC signature was produced by a BGP speaker belonging to a given AS. Thus, a goal of BGPSEC is to use signatures to protect the AS Path attribute of BGP update messages so that a BGP speaker can assess the validity of the AS Path in update messages that it receives. It should be understood, however, that the embodiments for implementing AS Path security disclosed herein are not limited to BGPSEC; certain embodiments may, additionally or alternatively, be applicable to other suitable protocols, including, for example, SoBGP, S-BGP, and PGPBGP, to name just a few.

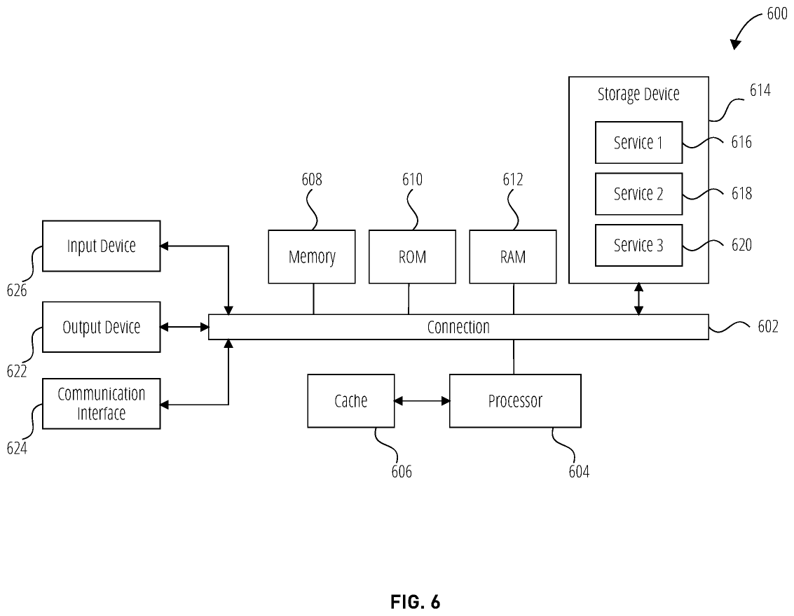

FIG. 6 illustrates an example of a computing system according to some aspects of the present technology. Example computing system 600 of FIG. 6 can be used to implement any of the devices described above with reference to FIGS. 1-5 including, but not limited to, priority user network device 302, managed network 306 and components thereof, etc. Components of computing system 600 may be in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (central processing unit (CPU) or processor) and connection 602 that couples various system components including system memory 608, read-only memory (ROM) 610, and random-access memory (RAM) 612 to processor 604. Computing system 600 can include cache 606 of high-speed memory 608 connected directly with, in close proximity to, or integrated as part of processor 604.

Processor 604 can include any general-purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the hardware components, such as processor 604, connection 602, output device 622, etc., to carry out the function.

For clarity of explanation, in some instances, the various examples can be presented as individual functional blocks comprising devices, device components, steps or routines in a method embodied in software, or combinations of hardware and software.

In some examples, the computer-readable storage devices, media, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware, and/or software, and can take various form factors. Some examples of such form factors include general-purpose computing devices such as servers, rack mount devices, desktop computers, laptop computers, and so on, or general-purpose mobile computing devices, such as tablet computers, smartphones, personal digital assistants, wearable devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method for enabling Emergency Preparedness Communications Service (EPCS) in a network, comprising:
receiving a request from a network device to establish a connection to the network, wherein the request indicates an occurrence of an emergency event and at least one user equipment associated with the emergency event;
prioritizing, for the device, access to the network based on the request in accordance with a resource allocation policy comprising a plurality of access levels associated with a plurality of EPCS groups;
allocating one or more network resources in accordance with the resource allocation policy to the network device, wherein the one or more network resources are configured to modify a set of attributes of the network device to grant the network device with an increased priority related to the emergency event; and
transmitting a message to the network device to indicate authorization for the network device to establish a connection with the network according to the increased priority.

2. The method of claim 1, wherein the resource allocation policy further comprises defining access levels, each access level being based on at least a type of emergency event and a location of the emergency event.

3. The method of claim 1, wherein the resource allocation policy further comprises defining access levels based on one or more priority levels for a number of user equipment associated with the emergency event, and a maximum medium time associated with each of the one or more priority levels.

4. The method of claim 1, wherein allocating the one or more network resources comprises:
monitoring utilization of the allocated network resources by the network device to identify compliance of the network device with the resource allocation policy;
identifying an increase in a priority related to the emergency event; and
in response to the identifying, updating the resource allocation policy to include access to the EPCS in the network for the at least one user equipment.

5. The method of claim 1, wherein the message transmitted to the network device includes instructions for establishing a secure and prioritized connection to the network in accordance with the resource allocation policy and the increased priority related to the emergency event.

6. The method of claim 1, further comprising:
receiving configuration information from an access network, wherein the configuration information specifies a limitation of emergency service to at least one EPCS group of the plurality of EPCS groups;
configuring the allocation of network resources to the network device based on the received configuration information in accordance with the resource allocation policy; and
wherein the limitation is specified via one or more bits in a Roaming Consortium Organization Identifier (RCOI).

7. The method of claim 1, further comprising:
receiving a traffic specification indicator from the network device indicating one or more Quality of Service (QoS) requirements for an application flow related to the emergency event;
analyzing the traffic specification indicator to identify a request to indicate priority for the application flow; and
processing the request at the network based on the authorization in accordance with the resource allocation policy, wherein the network accepts or rejects the request based on a priority level of the emergency event and availability of the one or more network resources at the network.

8. A network controller configured to enable Emergency Preparedness Communications Service (EPCS) in a network, comprising:
one or more memories having computer-readable instructions stored therein; and
one or more processors configured to execute the computer-readable instructions to:
receive a request from a network device to establish a connection to the network, wherein the request indicates an occurrence of an emergency event and at least one user equipment associated with the emergency event;
prioritize, for the device, access to the network based on the request in accordance with a resource allocation policy comprising a plurality of access levels associated with a plurality of EPCS groups;
allocate one or more network resources in accordance with the resource allocation policy to the network device, wherein the one or more network resources are configured to modify a set of attributes of the network device to grant the network device with an increased priority related to the emergency event; and
transmit a message to the network device to indicate authorization for the network device to establish a connection with the network according to the increased priority.

9. The network controller of claim 8, wherein the resource allocation policy further comprises defining access levels, each access level being based on at least a type of emergency event and a location of the emergency event.

10. The network controller of claim 8, wherein the resource allocation policy further comprises defining access levels based on one or more priority levels for a number of user equipment associated with the emergency event, and a maximum medium time associated with each of the one or more priority levels.

11. The network controller of claim 8, wherein the one or more processors are further configured to execute the computer-readable instructions to:
monitor utilization of the allocated network resources by the network device to identify compliance of the network device with the resource allocation policy;
identify an increase in a priority related to the emergency event; and
in response to identifying the increase, update the resource allocation policy to include access to the EPCS in the network for the at least one user equipment.

12. The network controller of claim 8, wherein the message transmitted to the network device includes instructions for establishing a secure and prioritized connection to the network in accordance with the resource allocation policy and the increased priority related to the emergency event.

13. The network controller of claim 8, wherein the one or more processors are further configured to execute the computer-readable instructions to:
receive configuration information from an access network, wherein the configuration information specifies a limitation of emergency service to at least one EPCS group of the plurality of EPCS groups;
configure the allocation of network resources to the network device based on the received configuration information in accordance with the resource allocation policy; and
wherein the limitation is specified via one or more bits in a Roaming Consortium Organization Identifier (RCOI).

14. The network controller of claim 8, wherein the one or more processors are further configured to execute the computer-readable instructions to:
receive a traffic specification indicator from the network device indicating one or more Quality of Service (QoS) requirements for an application flow related to the emergency event;
analyze the traffic specification indicator to identify a request to indicate priority for the application flow; and
process the request at the network based on the authorization in accordance with the resource allocation policy, wherein the network accepts or rejects the request based on a priority level of the emergency event and availability of the one or more network resources at the network.

15. One or more non-transitory computer-readable media comprising computer-readable instructions, which when executed by one or more processors of a network controller, cause the network controller to:
receive a request from a network device to establish a connection to the network, wherein the request indicates an occurrence of an emergency event and at least one user equipment associated with the emergency event;
prioritize, for the device, access to the network based on the request in accordance with a resource allocation policy comprising a plurality of access levels associated with a plurality of EPCS groups;
allocate one or more network resources in accordance with the resource allocation policy to the network device, wherein the one or more network resources are configured to modify a set of attributes of the network device to grant the network device with an increased priority related to the emergency event; and
transmit a message to the network device to indicate authorization for the network device to establish a connection with the network according to the increased priority.

16. The one or more non-transitory computer-readable media of claim 15, wherein the resource allocation policy further comprises defining access levels, each access level being based on at least a type of emergency event and a location of the emergency event.

17. The one or more non-transitory computer-readable media of claim 15, wherein the resource allocation policy further comprises defining access levels based on one or more priority levels for a number of user equipment associated with the emergency event, and a maximum medium time associated with each of the one or more priority levels.

18. The one or more non-transitory computer-readable media of claim 15, wherein the execution of the computer-readable instructions further cause the network controller to:
monitor utilization of the allocated network resources by the network device to identify compliance of the network device with the resource allocation policy;
identify an increase in a priority related to the emergency event; and
in response to identifying the increase, update the resource allocation policy to include access to the EPCS in the network for the at least one user equipment.

19. The one or more non-transitory computer-readable media of claim 15, wherein the message transmitted to the network device includes instructions for establishing a secure and prioritized connection to the network in accordance with the resource allocation policy and the increased priority related to the emergency event.

20. The one or more non-transitory computer-readable media of claim 15, wherein the execution of the computer-readable instructions further cause the network controller to:
receive configuration information from an access network, wherein the configuration information specifies a limitation of emergency service to at least one EPCS group of the plurality of EPCS groups;
configure the allocation of network resources to the network device based on the received configuration information in accordance with the resource allocation policy; and
wherein the limitation is specified via one or more bits in a Roaming Consortium Organization Identifier (RCOI).
